(19) United States
(12) Patent Application Publication
(10) Pub. No.: US 2004/0134976 A1
(43) Pub. Date: Jul. 15, 2004

(54) Method and system for solder connecting electrical devices

(76) Inventors: Frank Keyser, Elk Grove Village, IL (US); Robert Fuerst, West Bloomfield, MI (US)

Correspondence Address: MOLEX INCORPORATED, 2222 WELLINGTON COURT, LISLE, IL, 60532, US

(21) Appl. No.: 10/341,788

(22) Filed: Jan. 14, 2003

(51) Int. Cl. B23K 31/02

(52) U.S. Cl. 228/248.1; 228/180.21

(57) ABSTRACT

A system and method are disclosed for providing a solder joint between a pair of electrical devices which have juxtapositionable solderable portions. A solder material is provided between the solderable portions at the solder joint. A spacer material is suspended in the solder material to maintain the electrical devices spaced a predetermined distance from each other at the solder joint. The spacer material has a melting point higher than that of the solder material.

### FIELD OF THE INVENTION

This invention generally relates to the art of electrical connections and, particularly, to a system for providing a solder joint between a pair of electrical devices, including a method of solder connecting an electrical component to a solder pad on a circuit board.

### BACKGROUND OF THE INVENTION

Solder connections are used widely in the electrical industry for securing or connecting electrical devices to each other at a “solder joint”. A solder connection may be used to secure an electrical device to a base or substrate simply as a hold-down means, such as solder connecting an electrical component to a circuit board simply to hold the component onto the board. More often, conductive solder connections or joints are used to electrically interconnect a pair of conductors at an electrical interface. For instance, conductive terminals are solder connected to circuit traces on a printed circuit board. The terminals may range from surface-mounted terminal tails of an electrical connector to the terminals of an electrical component such as a capacitor.

Problems continue to be encountered with solder connections or joints as described above. In particular, if stresses are applied at levels beyond which a solder joint can withstand, the solder joint breaks and the electrical connection fails. Such breakage or failure often is the result of an insufficient thickness in the solder material at the solder joint. For instance, when a terminal is surface-connected to a circuit trace on a printed circuit board, gravity and surface tension tends to draw the parts together during the reflow soldering process which melts the solder material. While a “bead” of solder material may surround the terminal or component, the solder connection may end up with a micro-thin layer of solder material directly between the opposing surfaces of the components and substrate which are being soldered. It is well known that as the thickness of solder between the components increases, the strength and resistance to thermal fatigue of the solder joint also increases. Therefore, it is desirable to predictably control the thickness of solder between components. Although mechanical standoffs may be used to hold the components apart during the soldering process, this approach would be extremely expensive for mass production purposes. The present invention is directed to solving these problems in a unique method and system which incorporates spacer means directly in the solder material to space the components apart during a soldering process.

### SUMMARY OF THE INVENTION

An object, therefore, of the invention is to provide a system with a new and improved solder joint between a pair of electrical devices.

Another object of the invention is to provide a method of controlling the gap between a pair of electrical devices at a solder joint.

A further object of the invention is to provide a new and improved method of solder connecting an electrical component to a solder pad on a circuit board.

In the exemplary embodiment of the invention, a first electrical device is provided with a solderable portion. A second electrical device is provided with a solderable portion positionable adjacent the solderable portion of the first electrical device at a solder joint.

Solder paste is provided between the solderable portions at the solder joint. The solder paste includes a solder material having a given melting point and a spacer material having a melting point higher than that of the solder material. During heating of the solder paste, such as during a reflow soldering process, the solder paste is heated to a temperature at least equal to the melting point of the solder material but below the melting point of the spacer material which remains suspended in the solder joint to maintain the electrical devices spaced a predetermined distance from each other.

The above system or method allows the gap between the electrical devices, which is filled with solder material, to be varied simply by varying the dimensions of the spacer material in the solder paste and, thereby, controlling the gap between the electrical devices at the solder joint.

As disclosed herein, the spacer material comprises a plurality of particles having cross-dimensions which define the gap or distance that the electrical devices are spaced from each other at the solder joint. Specifically, the particles are provided by spacer spheres having predetermined diameters.

In the specific embodiment disclosed herein, an electrical component is shown soldered to at least one solder pad on a circuit board. Specifically, a capacitor having a pair of terminals is solder connected to a pair of circuit traces on the circuit board. In actual practice, spacer spheres having diameters on the order of 0.0017-0.0029 inch have been used in the solder paste to define a correspondingly dimensioned gap between the capacitor terminals and the circuit traces on the board.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a perspective view of a capacitor solder connected to circuit traces on a printed circuit board by solder joints according to the invention;

FIG. 2 is a top plan view of the circuit board and circuit traces;

FIG. 3 is a top plan view of the circuit traces, with solder paste according to the invention applied onto the circuit traces, and with the capacitor shown positioned on the solder paste in the left-hand half of the drawing;

FIG. 4 is a top plan view of FIG. 1;

FIG. 5 is a vertical section taken generally along line 5-5 of FIG. 4; and

FIG. 6 is a view similar to that of FIG. 5, but of a conventional or prior art solder joint.

### DETAILED DESCRIPTION OF THE PREFERRED EMBODIMENT

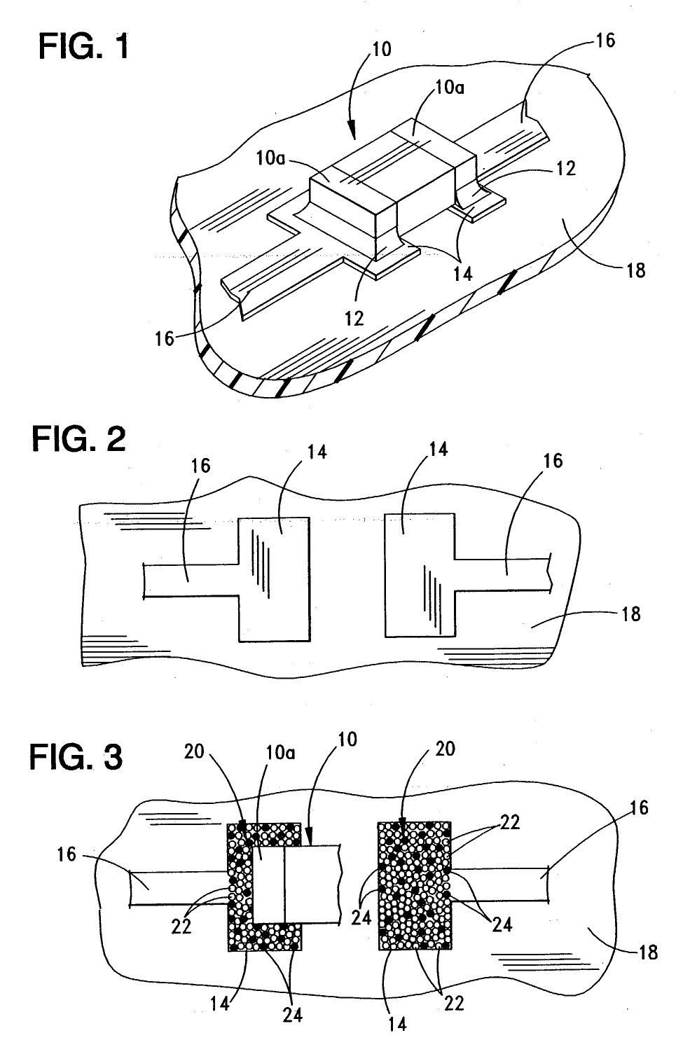

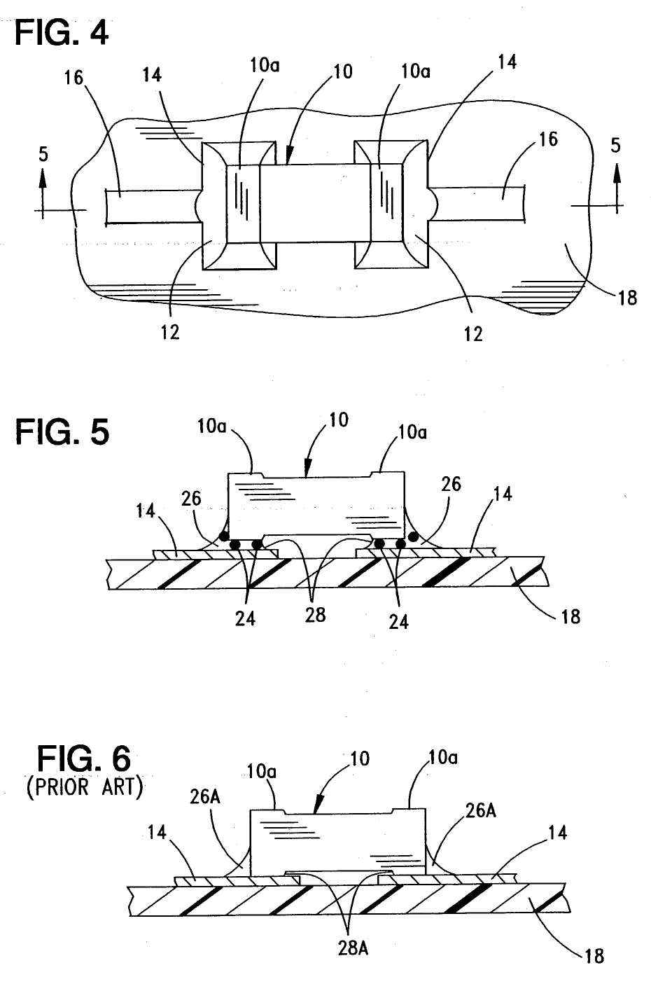

Referring to the drawings in greater detail, and first to′FIGS. 1 and 4, the invention is shown embodied in an electrical connector assembly which includes a capacitor, generally designated 10, solder connected at a pair of solder joints 12 to a pair of circuit pads 14 of appropriate circuit traces 16 on a printed circuit board 18. Capacitor 10 has a pair of terminal ends 10a which are solder connected to circuit pads 14 by conductive solder joints 12.

At this point, it should be understood that the solder joints of the invention are shown herein for electrically connecting capacitor 10 to circuit pads 14 on printed circuit board 18, for illustration purposes only. The invention has a wide range of applications for solder connecting a wide variety of electrical devices together at a solder joint. As but one example, electrical connectors, such as header connectors, mount a plurality of conductive terminals which have tail portions or “solder tails” which are solder connected to circuit traces on a variety of circuit boards including flat flexible circuits. Of course, the invention is equally applicable for controlling the gap between a wide variety of electrical devices at a solder joint, as will be evident from the description hereinafter.

With those understandings, FIG. 2 simply shows circuit board 18 with circuit pads 14 and circuit traces 16 before any solder paste is applied thereon. In other words, providing a first electrical device, such as a circuit board 18, would be a first step in a fabrication process utilizing the invention.

FIG. 3 shows a solder paste, generally designated 20, applied onto the top of circuit pads 14. As is known, a typical solder paste may include a plurality of solder spheres 22 suspended in a matrix of flux material. The spheres actually comprise the solderable material which is melted during heating, such as during a reflow soldering process. The spheres may be fabricated of a variety of materials, such as a tin/lead alloy, a copper/lead alloy, a bronze material which actually is copper with a tin coating, or the like. During heating, the solderable material, such as spheres 22, are melted at a given temperature or melting point. In essence, a soldering process involves a state change of spheres 22 from a solid state to a liquid state during heating and back to a solid state upon cooling. Therefore, after solder paste 20 is applied to circuit pads 14 as shown at the right-hand half of FIG. 3, and terminals 10a of capacitor 10 are positioned on top of the solder paste as shown in the left-hand half of FIG. 3, this assembly is heated, such as in a reflow soldering process, to melt spheres 22 to create a solder joint between terminals 10a and circuit pads 14, whereafter the solder joint is cooled or cured to solidify the solder material and lock the capacitor to printed circuit board 18 as seen in′FIGS. 1 and 4.

The invention contemplates a unique system for providing a predetermined gap between a pair of electrical devices at a solder joint, such as between capacitor terminals 10a and circuit pads 14, to increase the amount or thickness of solder material between those components. In fact, the invention provides a system by which such a gap can be varied or easily controlled simply by varying the composition of solder paste 20.

More particularly, FIG. 3 shows that solder paste 22 includes a plurality of particles or spacer spheres 24 in addition to spheres 22 of solder material. Spacer spheres 24 are mixed in and suspended within the flux matrix of solder paste 22 just as are spheres 22. Spacer spheres 24 are of a material which has a melting point higher than that of spheres 22 of solder material. For instance, if spheres 22 are of a tin/lead alloy, spacer spheres 24 may be of copper. The spacer spheres may also be of a tin/lead alloy but of a different composite ration to increase the melting point thereof.

With solder paste 20 comprising a composition of spheres 22 of solder material as well as spacer spheres 24, during the heating or reflow process, the solder paste is heated to a temperature at least equal to or above the melting point of spheres 22 but below the melting point of spacer spheres 24. Therefore, while spheres 22 melt under the influence of the applied heat, spacer spheres 24 remain in a solid state and maintain capacitor terminals 10a spaced from terminal pads 14 a distance determined by the size of the spacer spheres.

FIG. 5 shows a pair of completed solder joints 26 wherein spheres 22 (FIG. 3) in solder paste 20 have been melted and cured or cooled to a solid mass connecting capacitor 10 to printed circuit board 18; namely, connecting capacitor terminals 10a to circuit pads 14 on the circuit board. It should be noted that spacer spheres 24 remain suspended within solder joints 26 and define gaps 28 between terminals 10a and circuit pads 14. This gap is filled with the solder material formed by the melting of spheres 22.

As stated above, gap(s) 28 can be controlled or varied simply by varying the size of spacer spheres 24. In other words, if the diameters of spacer spheres 24 are increased, gap 28 is widened to increase the distance that capacitor terminals 10a are spaced from circuit pads 14. In actual practice spheres having diameters on the order of 0.0017-0.0029 inch have been used to create gaps of corresponding sizes. By increasing the gaps, the thickness of the solder material between the components is increased and the chances of failure due to solder joint breakage is significantly reduced.

Finally, FIG. 6 shows conventional solder joints 26A between a pair of capacitor terminals 10a and a pair of circuit pads 14 on a printed circuit board 18. It can be seen that the gaps 28A between the terminals and the circuit pads is practically negligible. In fact, only a micro-thin layer of solder material is left between the terminals and the circuit pads. This thin layer results from gravity and surface tension which draws the parts together and thins the molten solder during a solder heating or reflow process. The result is that the strength of solder joints 26A relies solely on the bead of solder created around the periphery of capacitor 10. In contrast to the invention of FIG. 5, it can be seen that solder joints 26 in FIG. 5 not only surround the capacitor, but a significant thickness of solder material is provided in gap 28 between capacitor terminals 10a and circuit pads 14.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

1. A method of solder connecting an electrical component to a solder pad on a circuit board, comprising the steps of:
providing a circuit board with a solder pad;
providing an electrical component having a solderable portion positionable on the solder pad at a solder joint;
applying a solder paste between the solder pad and the electrical component at said solder joint, the solder paste including a solder material having a given melting point and a spacer material having a melting point higher than that of the solder material; and
heating the solder paste to a temperature at least equal to the melting point of the solder material but below the melting point of the spacer material, whereby the spacer material remains suspended in the solder joint to maintain solderable portion of the electrical component spaced a given distance from the solder pad.

2. The method of claim 1 wherein said solder paste is applied to the solder pad and the electrical component then is positioned on the solder paste.

3. The method of claim 1 wherein said spacer material is provided as a plurality of spacer particles having cross-dimensions which define said given distance that the electrical component is spaced from the solder pad.

4. The method of claim 1 wherein said spacer material is provided as a plurality of spacer spheres having diameters which define said given distance that the electrical component is spaced from the solder pad.

5. The method of claim 4 wherein said spacer spheres have diameters on the order of 0.0017-0.0029 inch.

6. The method of claim 1 wherein said solder pad includes a pair of circuit traces.

7. The method of claim 6 wherein said electrical component comprises a capacitor having a pair of terminals positionable on the circuit traces with the solder paste applied therebetween.

8. A method of solder connecting an electrical component to a solder pad on a circuit board, comprising the steps of:
providing a circuit board with a solder pad;
applying a solder paste to said solder pad, the solder paste including a solder material having a given melting point and a plurality of spacer particles having a melting point higher than that of the solder material;
positioning a solderable portion of an electrical component on the solder paste on the solder pad at a solder joint; and
heating the solder paste to a temperature at least equal to the melting point of the solder material but below the melting point of the spacer particles,
whereby the spacer particles remain suspended in the solder joint to maintain the electrical component spaced a given distance from the solder pad as determined by the cross-dimensions of the spacer particles.

9. The method of claim 8 wherein said spacer particles comprise a plurality of spacer spheres having diameters which define said given distance that the electrical component is spaced from the solder pad.

10. The method of claim 9 wherein said spacer spheres have diameters on the order of 0.0017-0.0029 inch.

11. The method of claim 8 wherein said solder pad includes a pair of circuit traces.

12. The method of claim 11 wherein said electrical component comprises a capacitor having a pair of terminals positionable on the circuit traces with the solder paste applied therebetween.

13. A method of controlling the gap between a pair of electrical devices at a solder joint, comprising the steps of:
providing a first electrical device having a solderable portion;
providing a second electrical device having a solderable portion positionable adjacent the solderable portion of the first electrical device at a solder joint;
applying a solder paste between said solderable portions at said solder joint, the solder paste including a solder material having a given melting point and a spacer material having a melting point higher than that of the solder material; and
heating the solder paste to a temperature at least equal to the melting point of the solder material but below the melting point of the spacer material which remains suspended in the solder joint to maintain the electrical devices spaced a predetermined distance from each other,
whereby the dimensions of the spacer material can be varied to vary and, thereby, control the gap between the electrical devices at the solder joint.

14. The method of claim 13 wherein said spacer material is provided as a plurality of spacer particles having cross-dimensions which define said predetermined distance that the electrical devices are spaced from each other.

15. The method of claim 13 wherein said spacer material is provided as a plurality of spacer spheres having diameters which define said predetermined distance that the electrical devices are spaced from each other.

16. The method of claim 15 wherein said spacer spheres have diameters on the order of 0.0017-0.0029 inch.

17. A system for providing a solder joint between a pair of electrical devices, comprising:
a first electrical device having a solderable portion;
a second electrical device having a solderable portion positionable adjacent the solderable portion of the first electrical device at a solder joint;
solder material between said solderable portions at said solder joint; and
spacer material suspended in said solder material to maintain the electrical devices spaced a predetermined distance from each other at the solder joint.

18. The system of claim 17 wherein said spacer material has a melting point higher than the solder material.

19. The method of claim 18 wherein said spacer material is provided as a plurality of spacer particles having cross-dimensions which define said predetermined distance that the electrical devices are spaced from each other.

20. The method of claim 18 wherein said spacer material is provided as a plurality of spacer spheres having diameters which define said predetermined distance that the electrical devices are spaced from each other.

21. The method of claim 20 wherein said spacer spheres have diameters on the order of 0.0017-0.0029 inch.
